(19) United States
(12) Patent Application Publication
(10) Pub. No.: US 2005/0113109 A1
(43) Pub. Date: May 26, 2005

(54) Method, apparatus and system for context-based registrations based on intelligent location detection

(76) Inventors: Farid Adrangi, Lake Oswego, OR (US); Ranjit S. Narjala, Hillsboro, OR (US); Michael B. Andrews, Beaverton, OR (US)

Correspondence Address: INTEL CORPORATION, P.O. BOX 5326, SANTA CLARA, CA, 95056-5326, US

(21) Appl. No.: 10/723,814

(22) Filed: Nov. 25, 2003

(51) Int. Cl. G06F 15/16; H04Q 7/20

(52) U.S. Cl. 455/456.1; 709/217; 370/401

(57) ABSTRACT

A method, apparatus and system enable mobile nodes to determine their location and register with an appropriate home agent to provide seamless roaming between disparate networks. More specifically, according to one embodiment, a mobile node may include a policy engine, which may select one of a plurality of location modules. The mobile node may apply the selected location module to determine its location with respect to a corporate demilitarized zone (“DMZ”). If the mobile node determines that it is located on an intranet behind the corporate DMZ, it may register with an internal home agent on the intranet. If the mobile node determines that it is located on an external network, it may register with an external home agent on the external network and/or the corporate DMZ, establish a Virtual Private Network (“VPN”) tunnel to the corporate DMZ, and register with the internal home agent via the tunnel.

### FIELD

The present invention relates to the field of mobile computing, and, more particularly to a method, apparatus and system for mobile nodes to perform smart, context-based registrations utilizing an intelligent location detection scheme.

### BACKGROUND

Use of mobile computing devices (hereafter “mobile nodes”) such as laptops, notebook computers, personal digital assistants (“PDAs”) and cellular telephones is becoming increasingly popular today. These mobile nodes enable users to move from one location to another (“roam”), while continuing to maintain their connectivity to the same network. Given its increasing popularity, it is unsurprising that most corporate (“enterprise”) networks today attempt to facilitate fast and secure mobile computing.

In order to roam freely, networks typically conform to one or more industry-wide mobile iP standards. More specifically, the Internet Engineering Task Force (“IETF”) has promulgated roaming standards (Mobile iPv4, IETF RFC 3344, August 2002, hereafter “Mobile IPv4,” and Mobile IPv6, ETF Mobile IPv6, Internet Draft draft-ietf-mobileip-ipv6-24.txt (Work In Progress), June 2003, hereafter “Mobile IPv6”) to enable mobile node users to move from one location to another while continuing to maintain their connectivity to the same network.

### BRIEF DESCRIPTION OF THE DRAWINGS

The present invention is illustrated by way of example and not limitation in the figures of the accompanying drawings in which like references indicate similar elements, and in which:

FIG. 1 illustrates a known corporate intranet structure;

FIG. 2 illustrates a known enterprise network topology;

FIG. 3 illustrates a network topology according to the Dual HA Solution;

FIG. 4 illustrates conceptually an embodiment of the present invention; and

FIG. 5 is a flow chart illustrating embodiments of the present invention.

### DETAILED DESCRIPTION

Embodiments of the present invention provide a method, apparatus and system for mobile nodes to dynamically discover configuration information while roaming. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

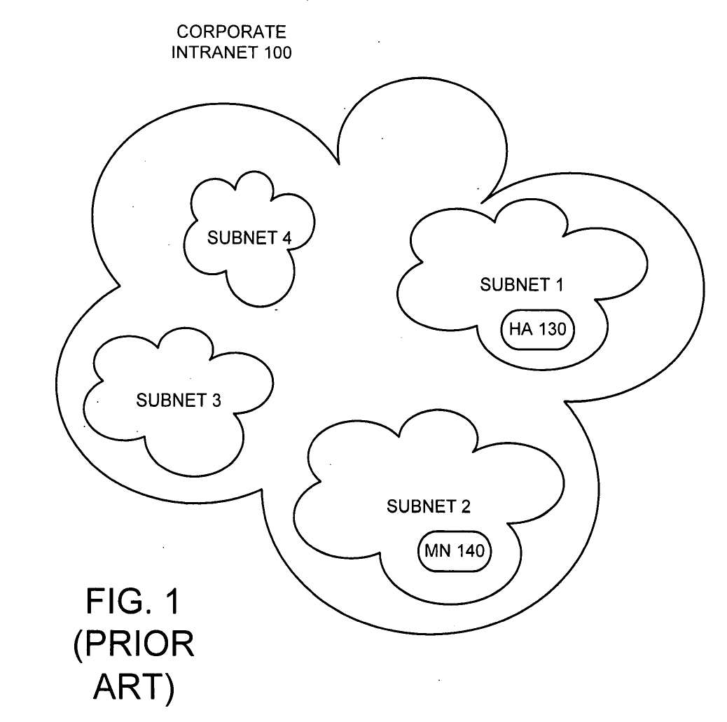

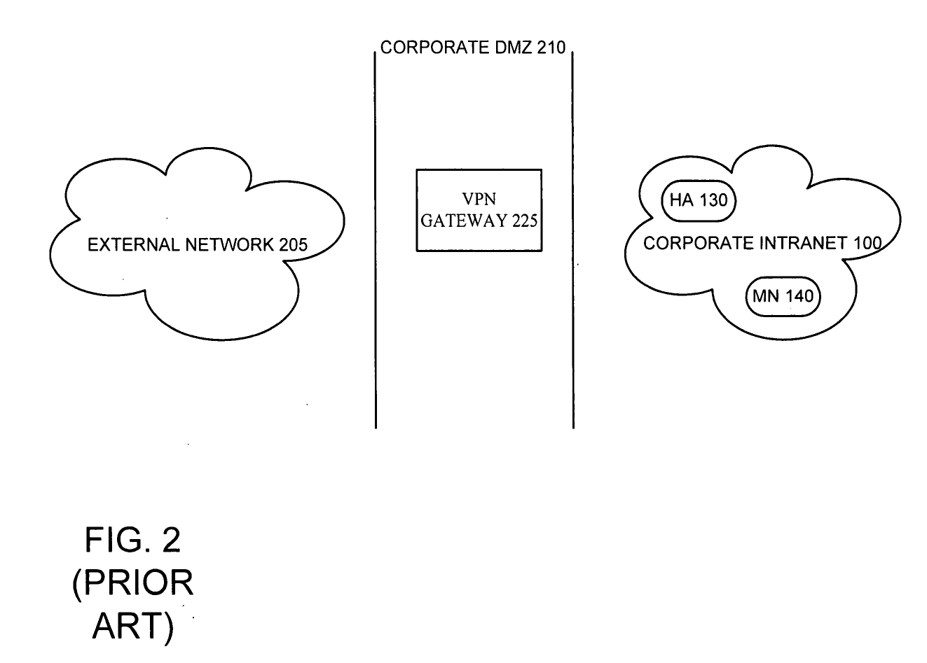

In order to facilitate understanding of embodiments of the present invention, FIG. 1 and FIG. 2 describe typical network topologies and roaming scenarios. Specifically, FIG. 1 illustrates a known corporate intranet (“Corporate Intranet 100”) structure. Corporate Intranet 100 may include both wired and wireless networks and may comprise multiple subnets. A subnet refers to a portion of an organization's network interconnected to other subnets by a routing element. Subnets are well known to those of ordinary skill in the art and further description thereof is omitted herein.

Mobile nodes that conform to Mobile IPv4 standards today may roam freely across subnets within Corporate Intranet 100. Thus, for example, when a mobile node (“MN 140”) exits its home subnet, it may continue to maintain its current transport connections and constant reachability in one of two ways. In the first scenario, MN 140 may register with a home agent (“HA 130”) when it exits its home subnet. During the registration process, MN 140 informs HA 130 of MN 140's home address (i.e., the invariant address assigned to MN 140) and its “care-of address” (hereafter “COA”), namely MN 140's address on its new subnet. HA 130 thereafter intercepts all IP packets addressed to MN 140' home address and reroutes the packets to MN 140's COA. As MN 140 moves from one subnet to another, MN 140 may obtain new COAs via Dynamic Host Configuration Protocol (“DHCP”) or other similar protocols. To ensure that HA 130 is able to properly route packets to MN 140, MN 140 must continuously update HA 130 with its new COA as it roams on Corporate Intranet 100.

Corporate Intranet 100 may also be connected to an external network, such as the Internet, and MN 140 may roam between Corporate Intranet 100 and the external network. FIG. 2 illustrates a known network topology today, comprising Corporate Intranet 100, separated from an external network (“External Network 205”) by a corporate demilitarized zone 210 (“Corporate DMZ 210”). Corporate DMZ 210 is well known to those of ordinary skill in the art and further description of such is omitted herein. Similar to Corporate Intranet 100, External Network 205 may also include both wired and wireless networks and comprise multiple subnets. For security purposes, Corporate DMZ 210 is likely to include security gateways such as Virtual Private Network (“VPN”) gateways (collectively illustrated in FIG. 2 as “VPN Gateway 225”) to protect Corporate Intranet 100 from External Network 205. VPN Gateway 225 also provides a secure means of communication between nodes on Corporate Intranet 100 and nodes on External Network 205 by encrypting the packets between the nodes on External Network 205 and Corporate Intranet 100. Since VPNs are likely to include security features such as IP Security (“IPSec”), all references herein to VPNs shall include IPSec-based VPNs, but embodiments of the present invention are not so limited. VPN gateways and IPSec are well known to those of ordinary skill in the art and further description thereof is omitted herein

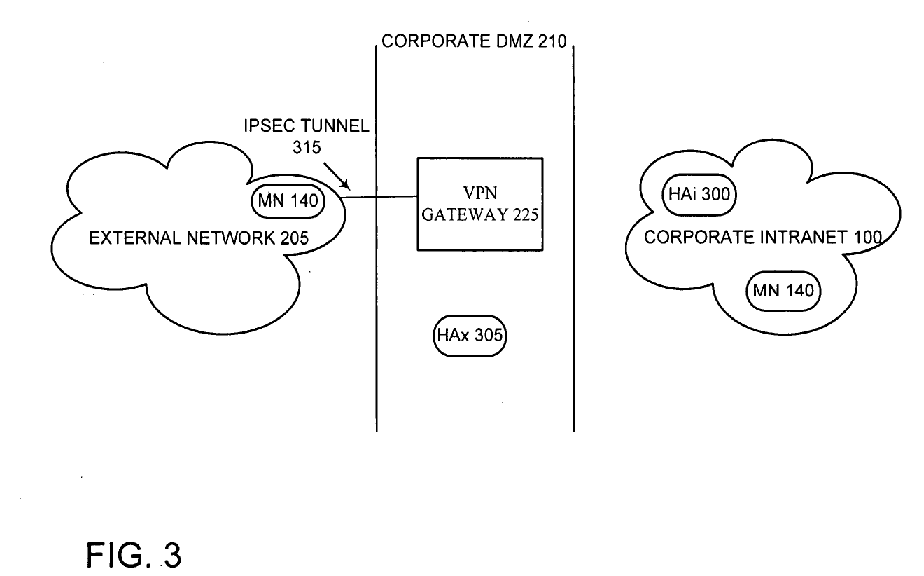

The presence of VPN Gateway 225 introduces a layer of complexity when MN 140 attempts to roam between Corporate Intranet 100 and External Network 205. One proposed solution to address the roaming problems that arise in this scenario is described in “Mobile IPv4 Traversal Across IPsec-Based VPN Gateways,” Internet Draft draft-ietf-mobileip-vpn-problem-solution-02.txt (Work In Progress), December 2002 (hereafter “Dual HA Solution”). According to the Dual HA Solution, MN 140 may register with two home agents when the MN roams on External Network 205 and wants to access resources inside Corporate Intranet 100 while maintaining its current transport sessions. FIG. 3 illustrates a network topology according to the Dual HA Solution. Specifically, as illustrated, the network topology may include at least two home agents, one (or more) located on Corporate Intranet 100 (“HAi 300”) and the other located external to Corporate Intranet 100 (“HAx 305”). “External” to Corporate Intranet 100 may include locations within Corporate DMZ 210 or on External Network 205. For the purposes of explanation, the following description assumes that HAx 305 is located within Corporate DMZ 210.

When MN 140 roams from Corporate Intranet 100 to External Network 205, MN 140 first registers with HAx 305, establishes an IPSec tunnel (“IPSec Tunnel 315”) to VPN Gateway 225 and registers (via IPSec Tunnel 315) with HAi 300. Thereafter, MN 140 may apply IPSec security protocols to all IP packets it transmits, and send these packets securely to nodes on Corporate Intranet 100 via IPSec Tunnel 315 and vice versa.

As MN 140 roams between Corporate Intranet 100 and External Network 205, there is currently no mechanism by which MN 140 may determine which network it is on. As a result, if MN 140 is on External Network 205, it may first attempt to register with HAi 300 without realizing that it is no longer within Corporate Intranet 100. When the registration attempt fails because HAi 300 resides behind Corporate DMZ 210, then MN 140 may register instead with HAx 305. Similarly, when MN 140 roams from External Network 205 to Corporate Intranet 100, it may attempt to register with HAx 305 before realizing that it is now within Corporate Intranet 100 and should register with HAi 300.

Embodiments of the present invention enable MN 140 to dynamically detect its location with respect to Corporate DMZ 210, and thereby determine whether to register with HAi 300 or HAx 305. Embodiments of the present invention therefore enable MN 140 to support continuous, secure and seamless connectivity as it roams moves between protected networks (e.g., Corporate Intranet 100) and unprotected networks (e.g., External Network 205). More specifically, embodiments of the present invention utilize a “policy engine” capable of selecting an appropriate methodology (hereafter “Location Module”) to dynamically determine MN 140's location with respect to Corporate DMZ 210. The policy engine and Location Module are described in further detail below.

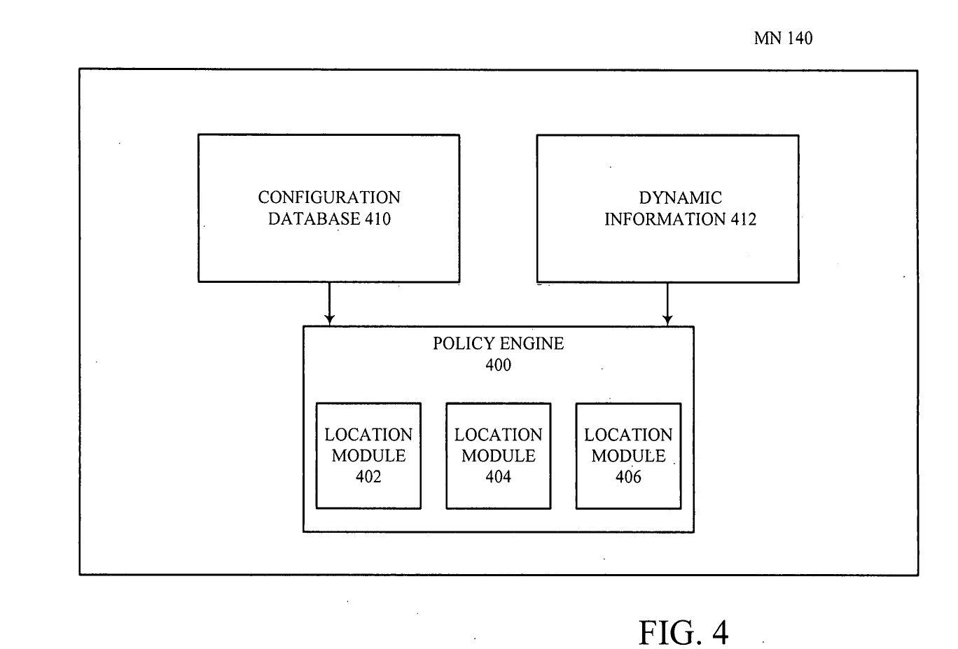

FIG. 4 illustrates conceptually an embodiment of the present invention. As illustrated, Policy Engine 400 may reside on MN 140. It will be readily apparent to one of ordinary skill in the art, however, that Policy Engine 400 may reside on a separate device coupled to MN 140 without departing from the spirit of embodiments of the present invention. Policy Engine 400 may include a variety of modules (illustrated as Location Modules 402-406) capable of instructing MN 140 to take appropriate action to determine its location with respect to Corporate DMZ 210. These instructions are contained within Location Modules, each suited for a particular network configuration and MN 140 configuration. In one embodiment, Policy Engine 400 may select a suitable Location Module based on information contained in a configuration database (illustrated as “Configuration Database 410”) and information dynamically discovered during the normal course of operation (illustrated as “Dynamic Information 412”). Upon applying the methodology of the selected Location Module, MN 140 may determine whether it is on Corporate Intranet 100 or External Network 205 and take appropriate action(s) (e.g., register with the appropriate home agent, establish an IPSec tunnel, etc.).

Configuration Database 410 may include information available when MN 140 is initially configured for use (e.g., by a system administrator and/or user). In one embodiment, Configuration Database 410 may include information such as the domain that MN 140 belongs to and the list of internet class (“CIDR”) block addresses assigned to Corporate Network 100. Configuration Database 410 may also be configured to know whether DHCP servers on Corporate Intranet 100 will include Domain Name information in DHCP replies and whether MN 140 will be roaming frequently between Corporate Intranet 100 and External Network 205. Dynamic Information 412 may include information dynamically gathered while MN 140 is roaming, including MN 140's domain name information in DHCP replies and information pertaining to whether MN 140 may register with HAx 305 from Corporate Intranet 100. Whether or not MN 140 may register with HAx 305 from Corporate Intranet 100 is typically based on the configuration of Corporate DMZ 210, although this information may also be configured statically on MN 140.

Thus, according to one embodiment of the present invention, when MN 140 starts up, Policy Engine 400 may initially select a default Location Module (e.g., Location Module 402, 404, 406 or 408) based on the information in Configuration Database 410. After MN 140 starts up, Policy Engine 400 may also acquire Dynamic Information 412 from the network that MN 140 is currently on, e.g., Corporate Intranet 100 or External Network 205. Based on Dynamic Information 412, Policy Engine 400 may make the determination whether to retain the default Location Module it initially selected, or whether to select a different Location Module to better suit the current network environment. The selected Location Module may then determine the location of MN 140 with respect to Corporate DMZ 210, and take the appropriate action(s), e.g., register with HAi 300 or HAx 305, establish IPSec tunnels as necessary, etc..

The following describes various Location Modules that may be used to configure MN 140 with appropriate information to register with HAi 300 and/or HAx 305. It will be readily apparent to those of ordinary skill in the art that the following description is merely exemplary and that various other Location Modules may be implemented without departing from the spirit of embodiments of the present invention.

A first Location Module (hereafter “Location Module 402”) may be appropriate in situations where MN 140 roams across Corporate DMZ 210 very frequently. In this scenario, the overall registration handoffs will suffer as the first registration request that MN 140 attempts will more likely fail than succeed. In this embodiment, MN 140 may not register across DMZ 210 (e.g., register directly with HAi 300 while on External Network 205 and/or register directly with HAx 305 while on Corporate Intranet 100). In one embodiment, when MN 140 starts up, Policy Engine 400 on MN 140 may be statically configured to know that MN 140 may not register across Corporate DMZ 210. In an alternate embodiment, Configuration Database 410 may inform Policy Engine 400 on MN 140 that MN 140 may not register across Corporate DMZ 210. Policy Engine 400 may therefore select Location Module 402, which may instruct MN 140 to launch simultaneous registration with HAi 300 and HAx 305 to improve the handoff performance. In this embodiment, MN 140 may receive a registration reply from HAi 300 and/or HAx 305 (whichever succeeds) and use this reply to determine its next action. Thus, for example, if the registration with HAi 300 succeeds and the registration with HAx 305 fails, then MN 140 may deduce that it is on Corporate Intranet 100 and proceed accordingly.

In an alternate embodiment, Dynamic Information 412 may inform Policy Engine 400 that although MN 140 may not be able to register directly with HAi 300 while on External Network 205, it may register directly with HAx 305 while on Corporate Intranet 100. According to this embodiment, Policy Engine 400 may still select Location Module 402 to launch simultaneous registrations to both HAi 300 and HAx 305. In this scenario, however, if MN 140 is on Corporate Intranet 100, it may receive two registration replies, one from each HAi 300 and HAx 305. If both the registrations succeed, MN 140 may be configured to deduce that it must be on Corporate Intranet 100 and therefore reject the registration reply from HAx 305. If, however, MN 140 is on External Network 205, it may still only receive one registration reply (because MN 140 still may not register directly with HAi 300 across Corporate DMZ 210) and deduce that it is on External Network 205.

A second Location Module (hereafter “Location Module 404”) may be used to detect MN 140's location using the domain name in the DHCP reply. If Policy Engine 400 determines based on information in Configuration Database 410 that the DHCP server on Corporate Intranet 100 may include domain name information in DHCP replies, Policy Engine 400 may select Location Module 404 to identify MN 140's location. More specifically, in this embodiment, DHCP servers on Corporate Intranet 100 may be configured to include a unique domain name in each DHCP reply. These DHCP replies may be verified by MN 140 using techniques well known to those of ordinary skill in the art (e.g., via methodologies promulgated by the ETF). When MN 140 acquires a DHCP address from a DHCP server on Corporate Intranet 100, it may examine the DHCP reply to identify an Intranet domain name in the reply. If it finds a domain name, that MN 140 may deduce that it is located on Corporate Intranet 100 and send a registration request to HAi 300. If MN 140 does not identify an Intranet domain name in the reply, it may deduce that it is on External Network 205 and instead send a registration request to HAx 305.

In this embodiment, if External Network 205 is managed by the same entity as Corporate Intranet 100 (e.g., a corporate WLAN), DHCP servers on External Network 204 may be configured with a different domain name to differentiate the network from Corporate Intranet 100. In this scenario, MN 140 may identify a domain name in the registration reply, but be able to associate the domain name with External Network 205 and therefore register with HAx 205.

A third Location Module (hereafter “Location Module 406”) may be utilized to detect MN 140's location using the COA assigned by the DHCP servers. In this embodiment, MN 140 may not register across Corporate DMZ 210 (e.g., register directly with HAi 300 while roaming on External Network 205 and/or register directly with HAx 305 while roaming on Corporate Intranet 100). According to an embodiment, Corporate Intranet 100 may be configured with routable CIDR block addresses and this information may be entered into Configuration Database 410 on MN 140. Policy Engine 400 may determine based on the information within the Configuration Database 410 to select Location Module 406, which may cause MN 140 to examine all COAs it receives from the DHCP server. More specifically, when MN 140 acquires a COA from the DHCP server, MN 140 may compare the COA address against the CIDR block addresses. If the COA is within the CIDR block addresses, then MN 140 may determine that it is on Corporate Intranet 100 and register with HAi 300. Otherwise, MN 140 may conclude that it is on External Network 205 and therefore register with HAx 305. In the event that MN 140 is in fact on External Network 205, but that the network has CIDR address blocks that overlap the CIDR address blocks on Corporate Intranet 100, MN 140 may wrongly deduce that it is on Corporate Intranet 100. When it tries to register with HAi 300 directly, however, the registration will fail and MN 140 may then register with HAx 305.

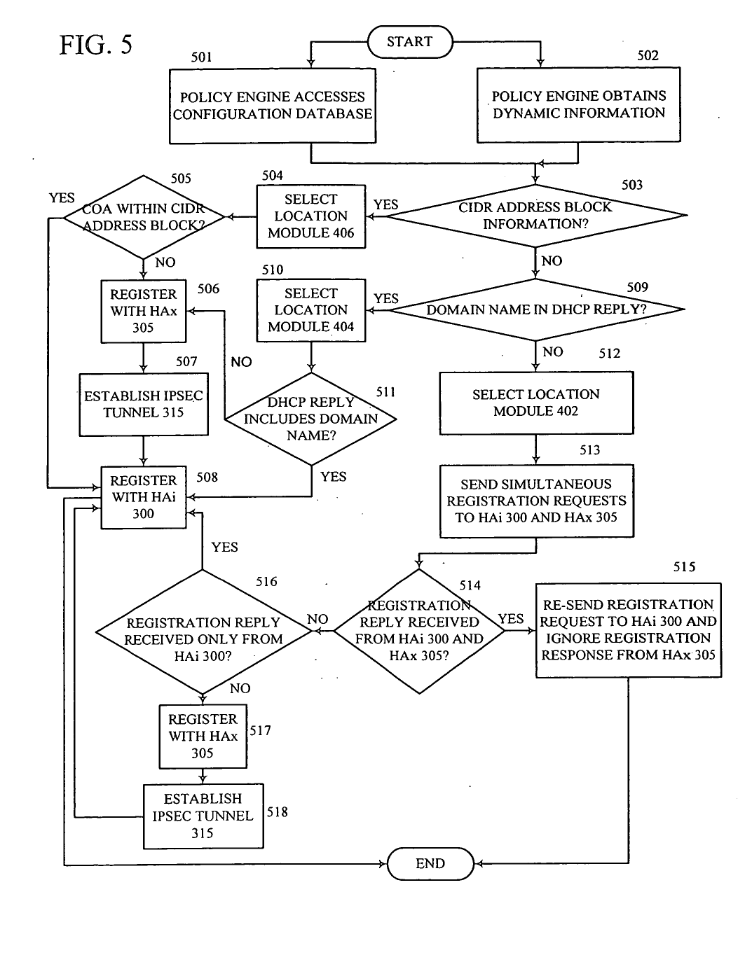

FIG. 5 is a flow chart illustrating an embodiment of the present invention. Although the following operations may be described as a sequential process, many of the operations may in fact be performed in parallel or concurrently. In addition, the order of the operations may be re-arranged without departing from the spirit of embodiments of the invention. In 501, Policy Engine 400 may access pre-configured information in Configuration Database 410. Additionally, in 502, Policy Engine 400 may obtain Dynamic Information 412. Based on the information in Configuration Database 410 and/or Dynamic Information 412, Policy Engine 400 may determine in 503 whether CIDR address block is used for Corporate Intranet 100. If it is available, Policy Engine 400 may select Location Module 406 in 504. In 505, MN 140 may apply Location Module 406 and compare its COA against the addresses in the CIDR address block in 505. If the address is not in the CIDR address block, then MN 140 may register with HAx 305 in 506, establish IPSec Tunnel 315 in 507 and then register via IPSec Tunnel 315 with HAi 300 in 508. If, however, the COA is within the CIDR address block, then MN 140 may register directly with HAi 300 in 508.

If Policy Engine 400 does not find CIDR address block information available in 503, it may then determine in 509 from the information in Configuration Database 410 and/or Dynamic Information 412 whether the DHCP servers include domain names in the DHCP replies. If the Policy Engine determines that the DHCP servers do include domain names in the DHCP replies, in 510 Policy Engine 400 may select Location Module 404. In 511, MN 140 may apply Location Module 404 and examine the DHCP reply to determine whether it includes a domain name. If the DHCP reply does include a domain name, MN 140 may proceed to register with HAi 300 in 508. If, however, the DHCP reply does not include a domain name, MN 140 may register with HAx 305 in 506, establish IPSec Tunnel 315 in 507 and register with HAi 300 via IPSec Tunnel 315 in 508.

If Policy Engine 400 determines in 509 from the information in Configuration Database 410 and/or Dynamic Information 412 that the DHCP servers do not include domain names in the DHCP replies, in 512, Policy Engine 400 may select Location Module 402. In applying Location Module 402, MN 140 may issue simultaneous registration requests to HAi 300 and HAx 305 in 513. MN 140 may then examine the registration response(s) it receives in 514. If MN 140 receives a registration response from both HAi 300 and HAx 305 in 515, it may re-send a registration request to HAi 300 and ignore the registration response from HAx 305. If, however, MN 140 does not receive a registration response from both HAi 300 and HAx 305, in 516, MN 140 may determine whether it received a registration response from HAi 300. If it did, MN 140 may register with HAi 300 in 508. If it did not, in 517, MN 140 may conclude that it received the registration response from HAx 305, establish IPSec Tunnel 315 is 518, and register with HAi 300 via IPSec Tunnel 315 in 508.

The mobile nodes, home agents and VPNs according to embodiments of the present invention may be implemented on a variety of data processing devices. It will be readily apparent to those of ordinary skill in the art that these data processing devices may include various software, and may comprise any devices capable of supporting mobile networks, including but not limited to mainframes, workstations, personal computers, laptops, portable handheld computers, PDAs and/or cellular telephones. In an embodiment, mobile nodes may comprise portable data processing systems such as laptops, handheld computing devices, personal digital assistants and/or cellular telephones. According to one embodiment, home agents and/or VPNs may comprise data processing devices such as personal computers, workstations and/or mainframe computers. In alternate embodiments, home agents and VPNs may also comprise portable data processing systems similar to those used to implement mobile nodes.

According to embodiment of the present invention, data processing devices may include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the data processing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of dynamically detecting a location of a mobile node, comprising:
examining information pertaining to the mobile node;
selecting a location module based on the information; and
executing the location module to determine whether the mobile node is on an intranet or an external network.

2. The method according to claim I wherein examining the information pertaining to the mobile node further comprises examining information from a configuration database and examining dynamic information obtained when the mobile node starts up.

3. The method according to claim 2 further comprising deciding whether to retain the location module based on the dynamic information.

4. The method according to claim 3 wherein deciding whether to retain the location module further comprises selecting an alternate location module if the dynamic information indicates the alternate location module is more suitable.

5. The method according to claim I wherein applying the location module further comprises causing the mobile node to execute instructions in the location module.

6. The method according to claim 5 wherein causing the mobile node to execute instructions in the location module further comprises causing the mobile node to register with an internal home agent and an external home agent.

7. The method according to claim 5 wherein causing the mobile node to execute instructions in the location module further comprises examining a Dynamic Host Control Protocol (“DHCP”) reply to determine a domain name.

8. The method according to claim 5 wherein causing the mobile node to execute instructions in the location module further comprises causing the mobile node to compare its care of address (“COA”) against a CIDR block address in a configuration database.

9. An article comprising a machine-accessible medium having stored thereon instructions that, when executed by a mobile node, cause the mobile node to:
examine information pertaining to a mobile node;
select a location module based on the information;
execute the location module to determine whether the mobile node is on an intranet or an external network.

10. The article according to claim 9 wherein the instructions, when executed by the mobile node, further cause the mobile node to examine information from a configuration database and examine dynamic information obtained when the mobile node starts up.

11. The article according to claim 10 wherein the instructions, when executed by the mobile node, further cause the mobile node to decide whether to retain the location module based on the dynamic information.

12. The article according to claim 11 wherein the instructions, when executed by the mobile node, further cause the mobile node to select an alternate location module if the dynamic information indicates the alternate location module is more suitable.

13. The article according to claim 9 wherein the instructions, when executed by the machine, further cause the mobile node to execute instructions in the location module.

14. The article according to claim 13 wherein the instructions, when executed by the mobile node, further cause the mobile node to register with an internal home agent and an external home agent.

15. The article according to claim 13 wherein the instructions, when executed by the mobile node, further cause the mobile node to examine a Dynamic Host Control Protocol (“DHCP”) reply to determine a domain name.

16. The article according to claim 13 wherein the instructions, when executed by the mobile node, further cause the mobile node compare its care of address (“COA”) against a CIDR block address in a configuration database.

17. A mobile node capable of dynamically determining its location, comprising:
a memory capable of storing a configuration database containing static information pertaining to the mobile node, the memory further capable of storing dynamic information obtained when the mobile node starts up; and
a processor capable of executing an appropriate location module selected by a policy engine, the appropriate location module selected by the policy engine based on the static information and the dynamic information, wherein the appropriate location module is capable of causing the mobile node to determine whether it is on an intranet or an external network.

18. The mobile node according to claim 17 wherein the processor is further capable of causing the policy module to select a first location module based on the static information in the configuration database, and wherein the processor is further capable of causing the policy engine to determine whether to retain the first location module.

19. The mobile node according to claim 18 wherein the processor is further capable of causing the policy engine to determine whether to retain the first location module based on the dynamic information.

20. The mobile node according to claim 19 wherein the processor is further capable of causing the policy engine to select an alternate location module as the appropriate location module if the dynamic information indicates the alternate location module is more suitable.

21. The mobile node according to claim 17 wherein the processor is further capable of executing instructions in the appropriate location module.

22. The mobile node according to claim 21 wherein the processor is further capable of causing the mobile node to register with an internal home agent and an external home agent.

23. The mobile node according to claim 21 wherein the processor is further capable of examining a Dynamic Host Control Protocol (“DHCP”) reply to determine a domain name.

24. The mobile node according to claim 21 wherein the processor is further capable comparing the mobile node's care of address (“COA”) against a CIDR block address in the configuration database.
